(19) United States
(12) Patent Application Publication
(10) Pub. No.: US 2010/0051051 A1
(43) Pub. Date: Mar. 4, 2010

(54) Dental floss Combined with Powders

(76) Inventor: Han-Chung HSU, Taipei City (TW)

Correspondence Address: HDLS Patent & Trademark Services, P.O. BOX 220746, CHANTILLY, VA, 20153-0746, US

(21) Appl. No.: 12/203,222

(22) Filed: Sep. 3, 2008

(51) Int. Cl. A61C 15/00

(52) U.S. Cl. 132/324; 132/321

(57) ABSTRACT

A dental floss adhered with powder includes a dental floss body that is adhered with grinding powder, cleansing powder, bactericidal powder or fluoride, concurrently or separately by means of a glue powder, such that, as the dental floss body inserting into crevices between teeth, tartars and plaques deposited on surfaces of teeth can be removed through the grinding powder, bacteria can be killed through the bactericidal powder and crevices between teeth can be cleaned through the cleansing agent, as well as an anti-carious effect can be achieved by the fluoride.

### BACKGROUND OF THE INVENTION

1. Field of the invention

The invention relates to a dental floss combined with powders, and in particular, to a dental floss combined with powders comprising mainly of a dental floss body to which is adhered with grinding powder, cleansing powder, bactericidal powder and fluoride, concurrently or separately, by means of an edible glue powder, so as to achieve the purpose of cleaning crevices between teeth.

2. Description of the Prior Art

A dental floss is a product composed by combining a plurality of parallel very thin nylon fibers or man-made fibers into a whole body in a manner that, as the dental floss is interposed into the crevice between adjacent teeth, said plurality of nylon fibers or man-made fibers can enter said crevice in a sense of behaving like a thin film such that the dental floss goes into the crevice by sticking over the surface of said adjacent teeth so as to erase off food residues present in the crevice, which thereby prevents said food residues from getting stuck in the crevice and thus imparting the user an unpleasant feeling.

Moreover, in order to increase the value added, conventionally, commercial manufacturer provides menthol on the dental floss so that the user can keep oral cavity fresh by using the dental floss and prevent off-flavor generated from slough or food residues remained in the interdental crevice

However, conventional dental floss has been provided only menthol thereon which can keep merely the oral cavity fresh but without functions of killing bacteria and cleansing interdental crevice.

Accordingly, the conventional goods have still many disadvantages, not of perfect design and need to be improved.

In view of the various disadvantages derived from the conventional dental floss, the inventor had thought to improve and innovate, and after studying intensively and diligently for many years, had developed successfully a dental floss combined with powders and thus accomplished the invention.

### SUMMARY OF THE INVENTION

One object of the invention is to provide a dental floss combined with powders, by adhering a dental floss body with grinding powder, cleansing powder, bactericidal powder and fluoride, concurrently or separately, by means of glue powder, so as to achieve the functions of cleaning crevices between teeth and killing bacterial therein, preventing dental caries and generation of off-flavor in oral cavity by means of said grinding powder, cleansing powder, bactericidal powder and fluoride.

Another object of the invention is to provide a dental floss combined with powders having many advantages such as easy fabrication, simple and convenient to use, having high practicability and the like.

The novel dental floss combined with powders that can achieve the above-described objects comprises a dental floss body, glue powder, grinding powder, cleansing powder, bactericidal powder and fluoride, wherein said grinding powder, cleansing powder, bactericidal powder and fluoride are adhered on the dental floss body, concurrently or separately, by means of the glue powder, thereby, as the dental floss body is inserted into the crevice between adjacent teeth, it can achieve objects of erasing off tartar and plaque deposited on the teeth through the grinding powder, killing bacterial through the bactericidal powder and cleansing the crevice through the cleansing powder, as well as preventing caries through the fluoride, thus supplementing the clean action that a common toothbrush cannot provide.

These features and advantages of the present invention will be fully understood and appreciated from the following detailed description of the accompanying drawings.

### BRIEF DESCRIPTION OF THE DRAWINGS

FIG. 1 is a schematic view of a dental floss combined with powders according to a first embodiment of the invention;

FIG. 2 is a schematic view of a dental floss combined with powders according to a second embodiment of the invention;

FIG. 3 is a schematic view of a dental floss combined with powders according to a third embodiment of the invention;

FIG. 4 is a schematic view of a dental floss combined with powders according to a fourth embodiment of the invention; and

FIGS. 5A, 5B, and 5C are schematic views showing the operation of the dental floss combined with powders according to the invention.

### DESCRIPTION OF THE PREFERRED EMBODIMENT

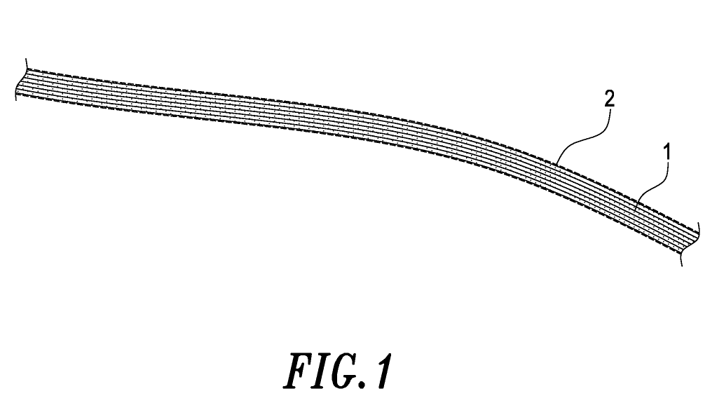

Referring to FIG. 1, a dental floss combined with powders provided by the invention, comprises mainly:

a dental floss body 1, said dental floss body 1 being composed by combining a plurality of parallel nylon fibers or man-made;

additives 2, said additives 2 comprising grinding powder and/or cleansing powder and/or bactericide and/or glue powder, wherein said grinding powder, cleansing powder, and bactericidal powder, are adhered onto the dental floss body 1, concurrently or separately, by means of said glue powder.

Further, said grinding powder may be made with calcium phosphate or other components.

Further, said cleansing powder may be made with sodium lauryl sulfate or other components.

Further, said glue powder may be made with natural algae or starch or other components.

Further, said bactericidal powder may be made with cetrimide or other components.

Further, said additives can contain fluoride.

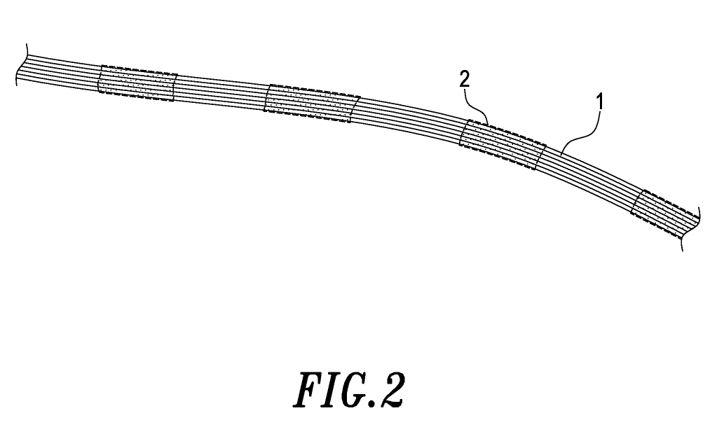

Referring to FIG. 2, a schematic view showing a second embodiment of the invention, the additive 2 comprising grinding powder, cleansing powder, bactericidal powder, glue powder or fluoride may be adhered at interval places on the dental floss body 1, while other constitutive structures are same as described in FIG. 1 and need not described further here.

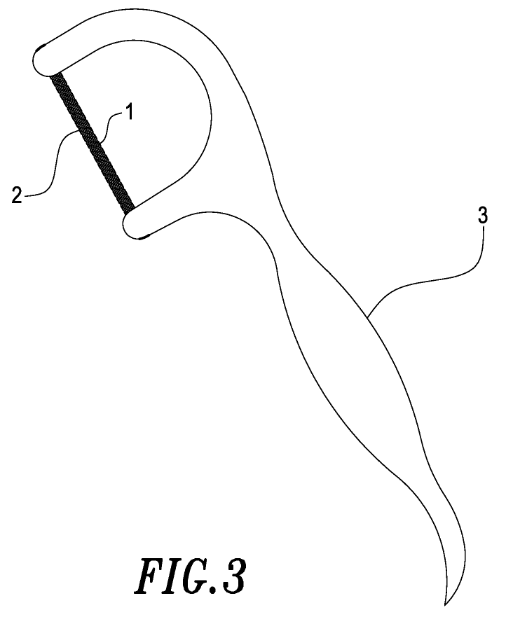

Referring to FIG. 3, a schematic view showing a third embodiment of the invention, the dental floss body 1 adhered with additive 2 thereon as described in FIG. 1 may combined with a dental flow pick 3 at a certain position.

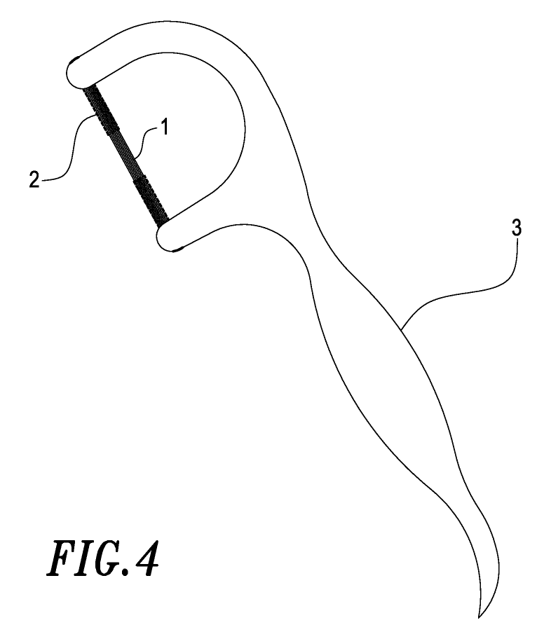

Referring to FIG. 4, a schematic view showing a fourth embodiment of the invention, the dental floss body 1 adhered with additive 2 thereon as described in FIG. 2 may combined with a dental flow pick 3 at a certain position.

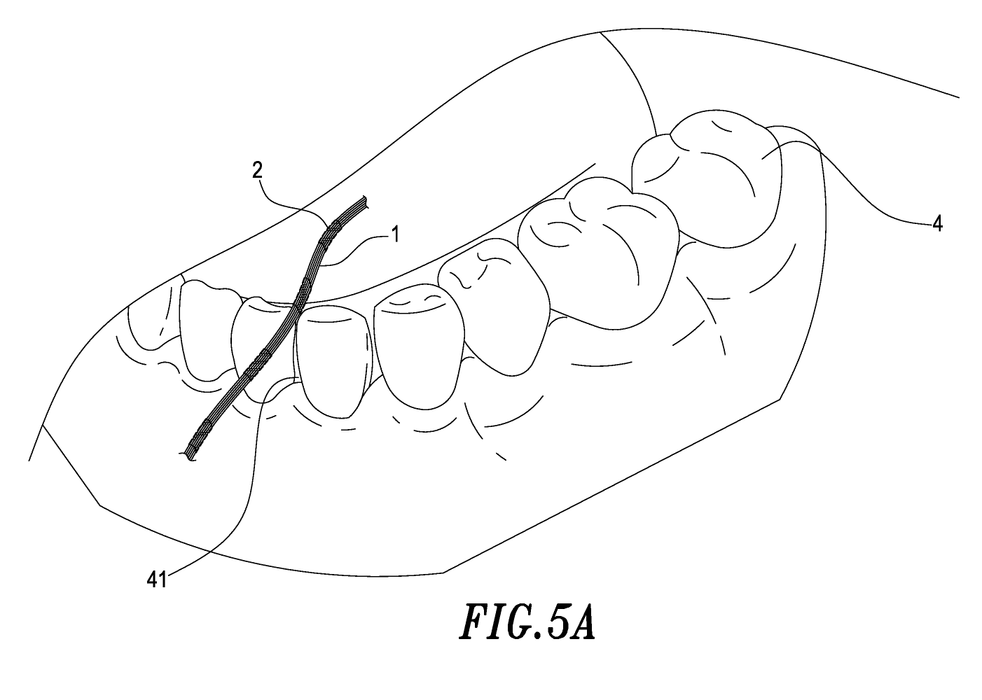

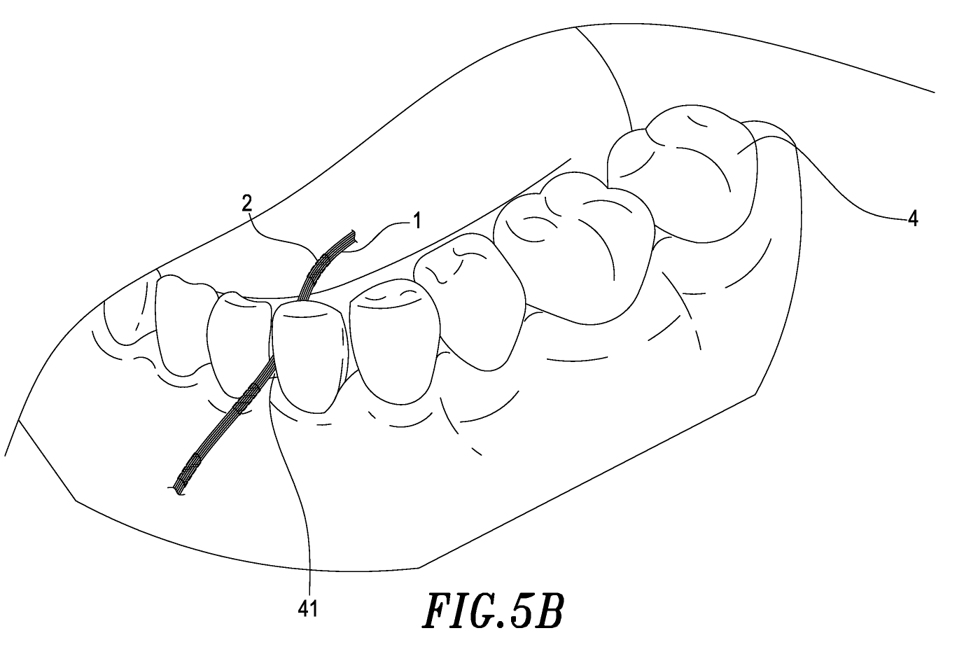

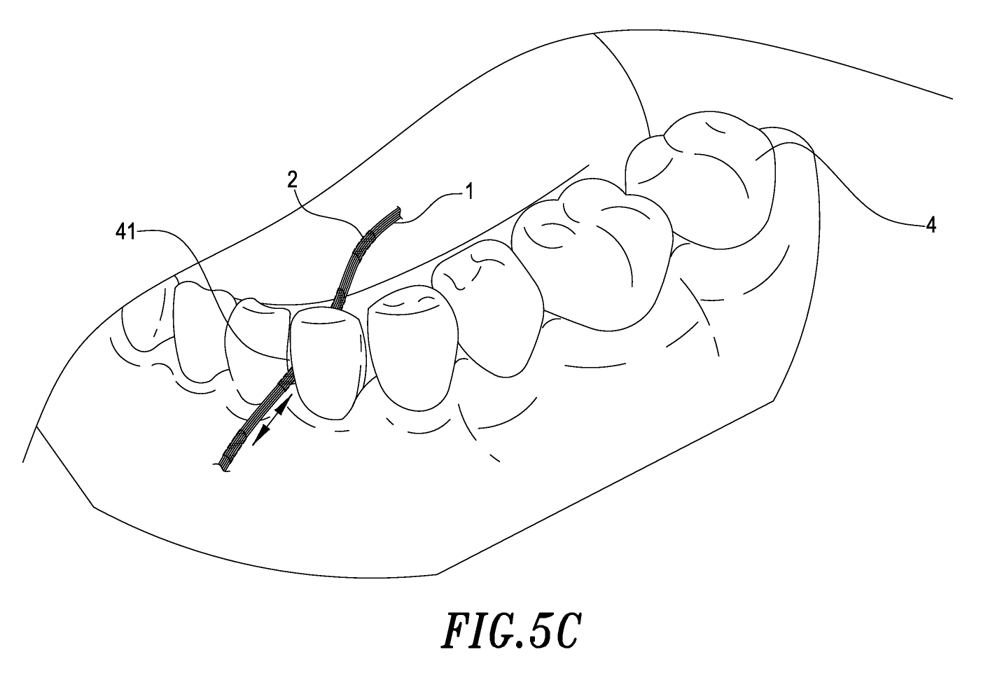

Referring to FIG. 5A, 5B and 5C, schematic views showing the operation of the dental floss according to the invention, in using the dental floss body 1, the dental floss body 1 is allowed to slip into the dental crevice 41 of teeth 4, and the dental floss body 1 is allowed to rub repeatedly against surfaces of teeth 4 on both sides of the dental crevice 41, whereby tartars and plaques deposited on surfaces of teeth 4 can be removed through the action of grinding powders, bacterial in oral cavity and dental crevice 41 can be killed through the action of the bactericidal powder, the dental crevice 41 can be cleaned through the action of the cleansing powder, and an effect of preventing caries can be achieved through the action of fluorides, and as such, the dental crevice 41 can be scraped and brushed by the dental floss body 1.

The dental floss combined with powders provided by the invention exhibits further following advantages over other conventional techniques:

1. The dental floss combined with powders according to the invention comprises of adhering grinding powder, bactericidal powder, cleansing powder and fluoride on a dental floss body by means of glue powder, thereby cleansing and bactericidal effects on dental crevices can be accomplished as well as caries and generation of off-flavor in oral cavity can be prevented through actions of the grinding powder, bactericidal powder, cleansing powder and fluoride.

2. The dental flow combined with powders according to the invention has various advantages such as easy fabrication, simple and convenient to use, high practicability and the like.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A dental floss combined with powders, comprising:
a dental floss body, composed by combining a plurality of fibers thread;
additives, comprising grinding powder and glue powder, wherein, said grinding powder is adhered on said dental floss body.

2. A dental floss combined with powders as recited in claim 1, wherein said additives contain further fluoride.

3. A dental floss combined with powders as recited in claim 1, wherein said grinding powder is calcium phosphate.

4. A dental floss combined with powders as recited in claim 1, wherein said glue powder is natural algae.

5. A dental floss combined with powders as recited in claim 1, wherein said glue powder is starch.

6. A dental floss combined with powders as recited in claim 1, wherein said dental floss body adhered with grinding powder thereon is combined on a dental floss pick at fixed position.

7. A dental floss combined with powders, comprising:
a dental floss body, composed by combining a plurality of fiber threads;
additives, comprising cleansing powder and glue powder, wherein, said cleansing powder is adhered on said dental floss body by means of said glue powder.

8. A dental floss combined with powders as recited in claim 7, wherein said additives contain further fluoride.

9. A dental floss combined with powders as recited in claim 7, wherein said cleansing powder is sodium lauryl sulfate.

10. A dental floss combined with powders as recited in claim 7, wherein said glue powder is natural algae.

11. A dental floss combined with powders as recited in claim 7, wherein said glue powder is starch.

12. A dental floss combined with powders as recited in claim 7, wherein said dental floss body adhered with cleansing powder thereon is combined on a dental floss pick at fixed position.

13. A dental floss combined with powders, comprising:
a dental floss body, composed by combining a plurality of fiber threads;
additives, comprising bactericidal powder and glue powder, wherein said bactericidal powder is adhered on said dental flow body by means of said glue powder.

14. A dental floss combined with powders as recited in claim 13, wherein said additives contain further fluoride.

15. A dental floss combined with powders as recited in claim 13, wherein said glue powder is natural algae.

16. A dental floss combined with powders as recited in claim 13, wherein said glue powder is starch.

17. A dental floss combined with powders as recited in claim 13, wherein said bactericidal powder is cetrimide.

18. A dental floss combined with powders as recited in claim 13, wherein said dental floss body adhered with said bactericidal powder thereon is combined on a dental floss pick at fixed position.
